(19) United States
(12) Patent Application Publication
(10) Pub. No.: US 2007/0069025 A1
(43) Pub. Date: Mar. 29, 2007

(54) Bar code reader with polygon mirror having curved reflection surfaces

(76) Inventor: Jerry Liao, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/235,223

(22) Filed: Sep. 27, 2005

(51) Int. Cl. G06K 7/10

(52) U.S. Cl. 235/462.4; 235/462.39

(57) ABSTRACT

A bar code reader includes a polygon mirror being located opposite to a laser beam projecting unit with a surrounding reflection mirror set arranged between them. The polygon mirror includes a plurality of sides, each of which is a curved reflection surface, and is driven by a motor to rotate, so that a laser beam projected from the projecting unit is reflected by the curved reflection surfaces of the polygon mirror and projected toward the surrounding reflection mirror set.

### FIELD OF THE INVENTION

The present invention relates to a laser bar code reader, and more particularly to a bar code reader with polygon mirror having curved reflection surfaces.

### BACKGROUND OF THE INVENTION

A bar code reader has been widely employed in various fields, such as a department store, a supermarket, a shopping mall, a warehouse, etc., as an electronic aid to assist workers in reading the prices and other information of different products in a quick and efficient manner. When the bar code reader is used with a computer, an automated management with reduced labor and upgraded working efficiency can be achieved.

Please refer to FIG. 1 that is a perspective view of a conventional omni-bearing bar code reader showing the relative positions of different components thereof, and to FIG. 2 that is a sectional view taken along line 2-2 of FIG. 1. The conventional omni-bearing bar code reader mainly includes a lower housing 1. A laser beam projecting unit 3 is located at one side in the lower housing 1 for projecting a laser beam.

The laser beam projecting unit 3 includes a laser diode seat 11 forming on the lower housing 1 for receiving a laser diode 2 therein. A raised compartment 12 is formed on a top of the laser diode seat 11 for inclinedly accommodating a first reflection lens 31 therein. A lens chamber 13 is formed in the lower housing 1 in the vicinity of the raised compartment 12. The lens chamber 13 has a first opening 131 provided at one lateral side facing toward the raised compartment 12 and a second opening 132 provided at a front side.

A second and a third reflection lens 32, 33 are arranged in the lens chamber 13. The first, the second, and the third lenses 31, 32, 33 are arranged at inclinations determined according to a required reflecting angle of the laser beam, such that a laser beam emitted from the laser diode 2 passes the first, the second, and the third reflection lens 31, 32, 33 and is projected via the second opening 132 at the front side of the lens chamber 13.

A polygon mirror 4 is located in the lower housing 1 at another side opposite to the laser beam projecting unit 3, and a surrounding reflection mirror set 5 is located between the third lens 33 and the polygon mirror 4 to surround the polygon mirror 4. A motor 41 is connected to a bottom of the polygon mirror 4 to drive the latter to rotate.

FIG. 3 shows an optical path in the above-described conventional omni-bearing bar code reader when the polygon mirror 4 is rotated by a certain angle; and FIG. 4 shows another optical path in the above-described conventional omni-bearing bar code reader when the polygon mirror 4 is rotated by another angle. As shown, when the laser beam emitted from the laser diode 2 sequentially passes the first, the second, and the third reflection lens 31, 32, 33, a laser beam L11 is projected from the third reflection lens 33 toward one corresponding reflection surface on the polygon mirror 4, from where the laser beam L11 is further reflected as a laser beam L12, which is projected toward one of the reflection mirrors in the surrounding reflection mirror set 5. The laser beam L12 is then reflected from the reflection mirror of the surrounding reflection mirror set 5 as a scanning laser beam, which is projected toward a target bar code to be read (not shown), so that the bar code is scanned and read. When the polygon mirror 4 is driven by the motor 41 to further rotate by an angle, the laser beam L11 projected toward the polygon mirror 4 will be reflected from one of the reflection surfaces of the polygon mirror 4 at a different angle to another reflection mirror of the surrounding reflection mirror set 5, as shown in FIG. 4. In this manner, another scanning laser beam is produced to read another target bar code, such that all the bar codes can be scanned and read.

A laser beam reflected from the target bar code will sequentially pass the above-mentioned optical path in a reverse direction. That is, the laser beam reflected from the target bar code sequentially passes the surrounding reflection mirror set 5, the polygon mirror 4, and the third reflection lens 33 to produce a return laser beam, which is then focused by a focusing lens 34 inside the lower housing 1 and projected toward a photo-sensor element, such as a photo diode, provided at a predetermined position on a bottom of the bar code reader, so that the return laser beam is received for reading out the scanned bar code via a control circuit.

While the above-described conventional bar code reader provides pretty good bar code reading effect, it has limited scanning angle and less satisfying ability in gathering and returning the laser beam due to a polygon mirror having planar reflection surfaces, which have limited reflecting angle to adversely affect the reflection of the laser beam.

For example, in a polygon mirror having four reflection surfaces, each of the planar reflection surfaces has a reflecting angle always smaller than 180°. Moreover, the planar reflection surfaces of the polygon mirror only reflect the laser beam without any light-gathering function.

Therefore, it is necessary to develop an improved polygon mirror for the bar code reader, so that the laser beam could be reflected at an expanded reflecting angle and efficiently gathered.

### SUMMARY OF THE INVENTION

A primary object of the present invention is to provide a bar code reader having an improved polygon mirror structure that provides an expanded scanning angle.

Another object of the present invention is to provide a bar code reader having better laser beam focusing effect. The bar code reader includes an improved polygon mirror structure, which has better light-gathering ability when it reflects a laser beam.

To achieve the above and other objects, the bar code reader according to the present invention includes a polygon mirror being located opposite to a projecting unit with a surrounding reflection mirror set arranged between them. The polygon mirror includes a plurality of sides, each of which is a curved reflection surface, and is driven by a motor to rotate, so that a laser beam projected from the projecting unit is reflected by the curved reflection surfaces of the polygon mirror and projected toward the surrounding reflection mirror set.

The bar code reader with polygon mirror having curved reflection surfaces according to the present invention not only provides proper light-gathering effect when the polygon mirror reflects a laser beam, but also provides expanded scanning angle to obtain an optimized scanning effect. Moreover, since the curved reflection surfaces of the polygon mirror of the present invention provides expanded scanning angle, much more denser scanning lines can be produced and projected toward the bar codes to be scanned to enable a better bar code scanning effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view showing the relative positions of different components in a conventional omni-bearing bar code reader;

FIG. 2 is a sectional view taken along line 2-2 of FIG. 1;

FIG. 3 shows an optical path in the conventional omni-bearing bar code reader of FIG. 1 when a polygon mirror thereof is rotated by a certain angle;

FIG. 4 shows another optical path in the conventional omni-bearing bar code reader of FIG. 1 when the polygon mirror thereof is rotated by another angle;

FIG. 5 is perspective view of a bar code reader with polygon mirror having curved surfaces according to the present invention;

FIG. 6 is an exploded perspective view of FIG. 5;

FIG. 7 is a top plan view of the bar code reader of the present invention;

FIG. 8 is a front view of the bar code reader of the present invention; and

FIG. 9 is a sectional view taken along line 9-9 of FIG. 6.

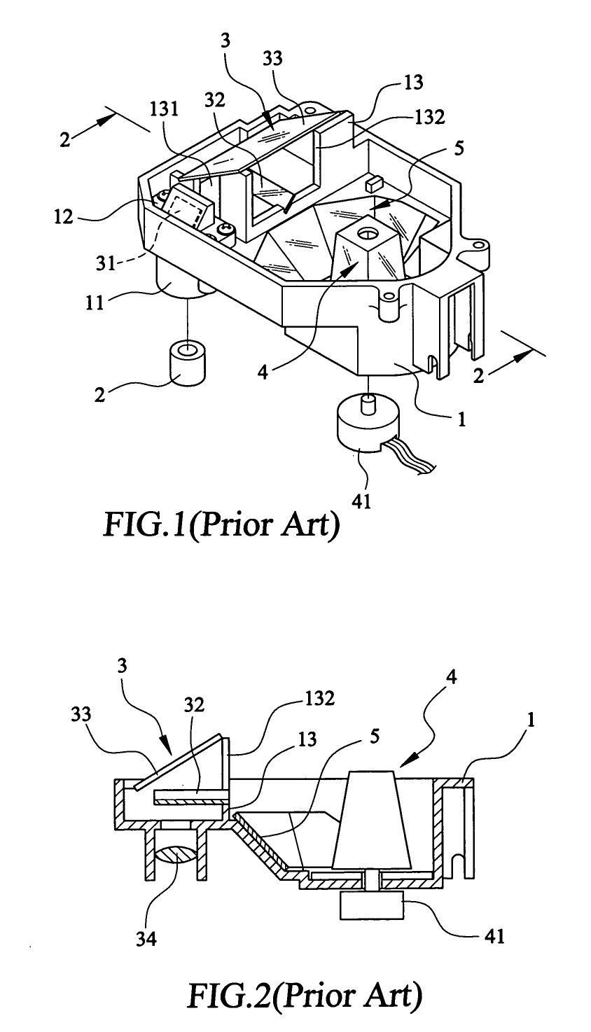

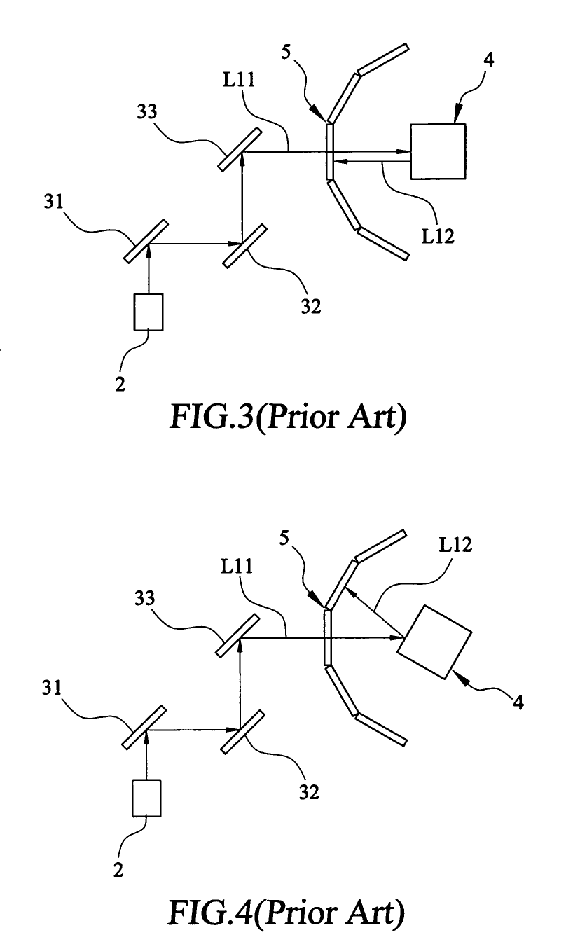

### DETAILED DESCRIPTION OF THE PREFERRED EMBODIMENTS

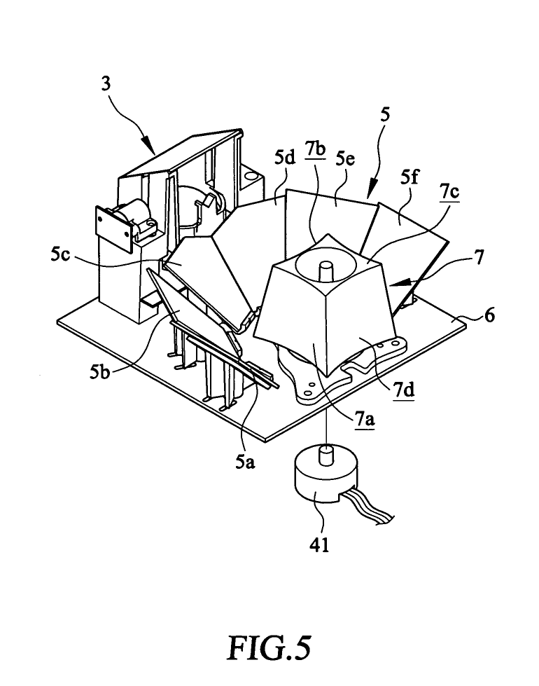

Please refer to FIG. 5 that is a perspective view of a bar code reader with polygon mirror having curved reflection surfaces according to the present invention. As shown, the bar code reader of the present invention includes a base 6, on one side of which a laser beam projecting unit 3 is provided. As in the conventional bar code reader, the laser beam projecting unit 3 also includes a laser diode and a plurality of reflection lenses for projecting a laser beam.

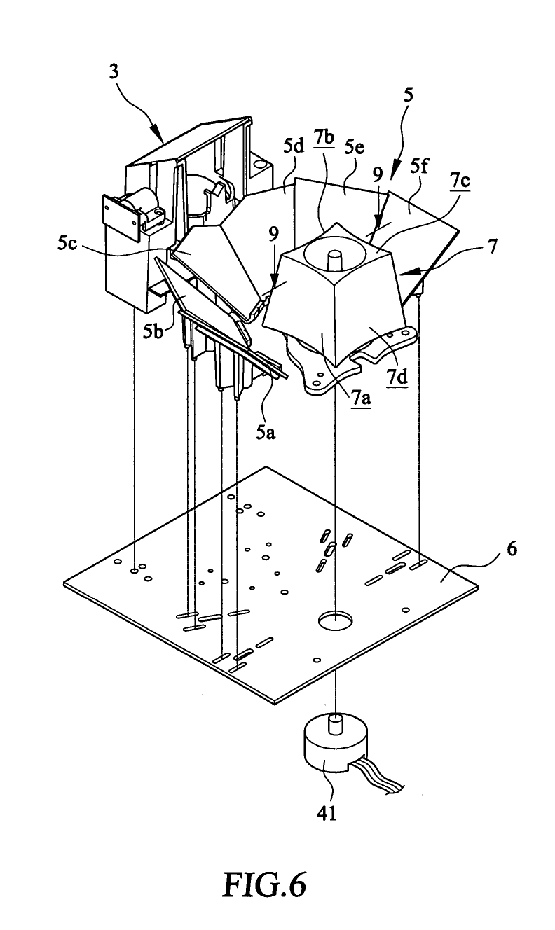

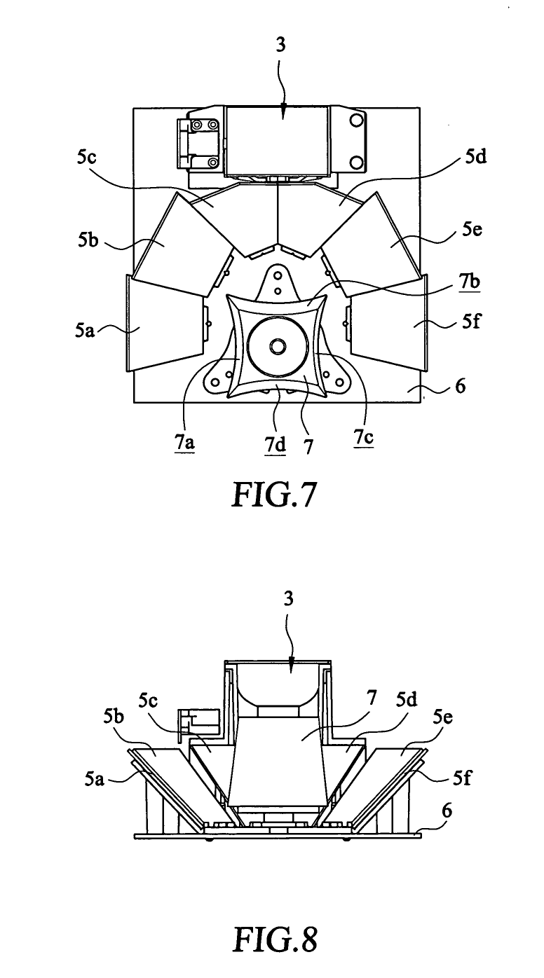

Please refer to FIGS. 6, 7, and 8 that are exploded perspective view, top plan view, and front view of the bar code reader of FIG. 5, respectively. As shown, a polygon mirror 7 is provided on the base 6 at a position opposite to the laser beam projecting unit 3, and a surrounding reflection mirror set 5 is arranged between the laser beam projecting unit 3 and the polygon mirror 7. As in the conventional bar code reader, a motor 41 is connected to a bottom of the polygon mirror 7 to drive the polygon mirror 7 to rotate at a predetermined speed.

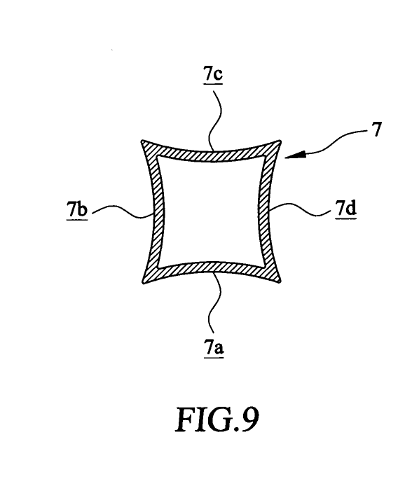

FIG. 9 is a sectional view taken along line 9-9 of FIG. 6. In the present invention, each side of the polygon mirror 7 is a curved reflection surface. In the illustrated drawings, the polygon mirror 7 has four curved reflection surfaces 7a, 7b, 7c, and 7d, all of which are concave curved surfaces.

The curved reflection surface at each side of the polygon mirror 7 may be, in addition to a concave curved surface, a spherical surface or a non-spherical surface. The curved reflection surface 7a, 7b, 7c, 7d has a curvature that is determined depending on a size of the polygon mirror 7, and optical distances between the laser beam projecting unit 3 and the surrounding reflection mirror set 5 as well as between the surrounding reflection mirror set 5 and the polygon mirror 7.

The curved reflection surfaces 7a, 7b, 7c, and 7d of the polygon mirror 7 have an optical reflecting material coated thereon to form the reflection surfaces. In actual production of the present invention, it is possible to directly form the reflection surfaces for the polygon mirror 7 by way of molding. Alternatively, the reflection surfaces may be formed by way of coating an optical reflecting material over curved surfaces on a basic body.

In the embodiment shown in the illustrated drawings, the polygon mirror 7 includes four curved reflection surfaces 7a, 7b, 7c, and 7d, each of which has an expanded reflecting angle of 270° to reflect the laser beam projected from the unit 3. This reflecting angle of 270° is larger than the reflecting angle of 180° that can be provided by the conventional polygon mirror 4 having four planar reflection surfaces. In the present invention, the surrounding reflection mirror set 5 may include six reflection mirrors 5a, 5b, 5c, 5d, 5e, and 5f to match the polygon mirror 7 having four concave curved reflection surfaces 7a, 7b, 7c, and 7d. In this manner, the bar code reader of the present invention may generate and project much more denser scanning lines toward the target bar codes to be read, and is therefore helpful in reading bar codes more efficiently.

What is claimed is:

1. A bar code reader with a polygon mirror having curved reflection surfaces, comprising a base, a laser beam projecting unit provided on one side of said base, a polygon mirror located on said base opposite to said laser beam projecting unit, and a surrounding reflection mirror set provided on said base between said laser beam projecting unit and said polygon mirror; said polygon mirror including a plurality of sides, each of which is a curved reflection surface, and being driven by a motor connected to a bottom thereof to rotate, so that a laser beam projected from said laser beam projecting unit is reflected from one of said curved reflection surfaces of said polygon mirror and projected toward said surrounding reflection mirror set.

2. The bar code reader with polygon mirror having curved reflection surfaces as claimed in claim 1, wherein said polygon mirror includes at least three sides, each of which is a curved reflection surface.

3. The bar code reader with polygon mirror having curved reflection surfaces as claimed in claim 1, wherein each of said curved surfaces of said polygon mirror is coated with an optical reflecting material to form said reflection surface.
